(19) United States
(12) Patent Application Publication
(10) Pub. No.: US 2012/0036786 A1
(43) Pub. Date: Feb. 16, 2012

(54) ADJUSTABLE GATE MOUNTING HINGE

(76) Inventor: Edward J. Stull, Oxford, MI (US)

(21) Appl. No.: 13/207,936

(22) Filed: Aug. 11, 2011

Related U.S. Application Data
(60) Provisional application No. 61/372,614, filed on Aug. 11, 2010.

(51) Int. Cl. E05D 7/04; E06B 3/36; E05F 1/12

(52) U.S. Cl. 49/399; 16/235; 16/249; 49/506

(57) ABSTRACT

A mounting hinge for supporting a movable gate includes a mounting plate attachable to a fixed structure and an adjustment member constrained from horizontal movement by the mounting plate. The mounting hinge also includes a gate supporting member engaged with the adjustment member and movable responsive to a rotation of the adjustment member relative to the mounting plate.

### REFERENCE TO RELATED APPLICATIONS

This application claims priority to U.S. Provisional Application Ser. No. 61/372,614 filed Aug. 11, 2010.

### BACKGROUND OF THE INVENTION

This disclosure relates generally to a gate mounting hinge. More particularly, this disclosure relates to a gate mounting hinge that is adjustable while supporting a gate.

A gate is typically supported by hinges attached to a fixed post or other fixed structure. One type of gate hinge utilizes a “J” shaped bolt that extends into a portion of a movable gate. A distance between the fixed post and the gate is adjusted to provide a desired gate alignment with another gate or a second fixed post. This distance is typically adjustable by rotating the “J” bolt.

As appreciated, because the vertical portion of the “J” bolt is required to be facing in a given direction, adjustment is limited to a complete turn of the bolt. In other words, to adjust the distance and thereby gate alignment, the “J” bolt must be turned a full turn. Moreover, the adjustment can only be accomplished with the “J” bolt free of the gate. In such instances, it can be difficult to determine if the gate is properly adjusted until reassembled and therefore increase the effort and time required to provide a desired alignment of the gate assembly.

### SUMMARY OF THE INVENTION

A mounting hinge for supporting a movable gate includes a mounting plate attachable to a fixed structure and an adjustment member constrained from horizontal movement by the mounting plate. The mounting hinge also includes a gate supporting member engaged with the adjustment member and movable responsive to a rotation of the adjustment member relative to the mounting plate.

A movable gate includes a mounting plate attachable to a fixed post, an adjustment member constrained from horizontal movement by the mounting plate, and a gate supporting member engaged with the adjustment member and movable responsive to a rotation of the adjustment member relative to the mounting plate. The gate supporting member includes a horizontal threaded portion received in a hole in the adjustment member and a vertical portion. The moveable gate includes a rotatable gate, and the vertical portion of the gate supporting member is received within an opening of a post of the rotatable gate.

A method of adjusting a position of a movable gate includes the steps of attaching a mounting plate to a fixed support and constraining movement of an adjustment member supported by the mounting plate. The method includes the steps of supporting a movable gate support member with the adjustment member and rotating the adjustment member to move the gate support member relative to the fixed support to a desired position indicative of a desired gate alignment.

These and other features of the present invention can be best understood from the following specification and drawings, the following of which is a brief description.

### BRIEF DESCRIPTION OF THE DRAWINGS

FIG. 1 is a schematic view of an example gate assembly;

FIG. 2 is a perspective view of an example adjustable mounting hinge;

FIG. 3 is a cross-sectional view of the example adjustable mounting hinge as shown in FIG. 2;

FIG. 4 is a perspective view of an example adjustable mounting hinge;

FIG. 5 is a cross-sectional view of the example adjustable mounting hinge as shown in FIG. 4;

FIG. 6 is a perspective view of an example adjustable mounting hinge;

FIG. 7 is a cross-sectional view of the example adjustable mounting hinge as shown in FIG. 6;

FIG. 8 is a perspective view of an example adjustable mounting hinge;

FIG. 9 is a cross-sectional view of the example adjustable mounting hinge as shown in FIG. 8;

FIG. 10 is a perspective view of an example adjustable mounting hinge;

FIG. 11 is a cross-sectional view of the example adjustable mounting hinge as shown in FIG. 10;

FIG. 12 is a perspective view of an example adjustable mounting hinge;

FIG. 13 is a cross-sectional view of the example adjustable mounting hinge as shown in FIG. 12;

FIG. 14 is a perspective view of an example adjustable mounting hinge;

FIG. 15 is a cross-sectional view of the example adjustable mounting hinge as shown in FIG. 14;

FIG. 16 is a perspective view of an example clamp to be attached to a post of a gate;

FIG. 17 is a top view of the example clamp as shown in FIG. 16; and

FIG. 18 is a cross-sectional view view of the example clamp as shown in FIG. 16.

### DETAILED DESCRIPTION OF THE PREFERRED EMBODIMENTS

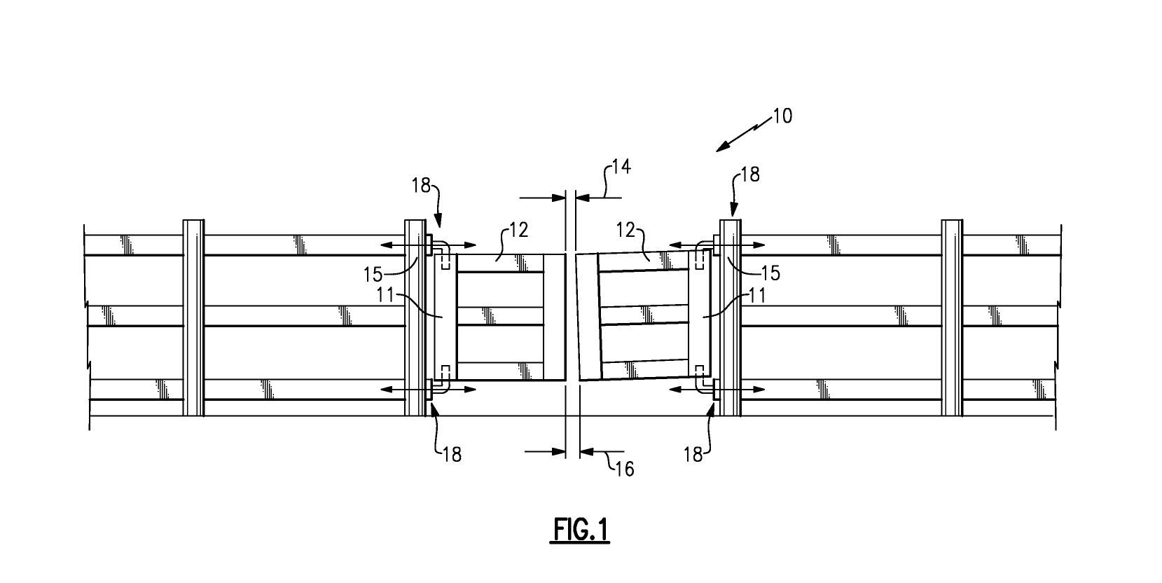

Referring to FIG. 1, a gate assembly 10 is provided between fixed posts 15 of a fence. The gate assembly 10 includes movable gates 12. Each of the gates 12 are mounted for movement relative to the fixed posts 15 by mounting hinges 18. The gates 12 can pivot relative to the fixed posts 15. A top gap 14 and a bottom gap 16 between the gates 12 are adjustable by adjusting each of mounting hinges 18 away from or toward a corresponding fixed post 15. The horizontal movement of the mounting hinges 18 provide for the adjustment of the gaps 14 and 16 between the gates 12 to provide a desired alignment. As should be appreciated, although the disclosed gate assembly 10 includes two gates 12, a gate assembly including a single gate 12 will also benefit from this disclosure.

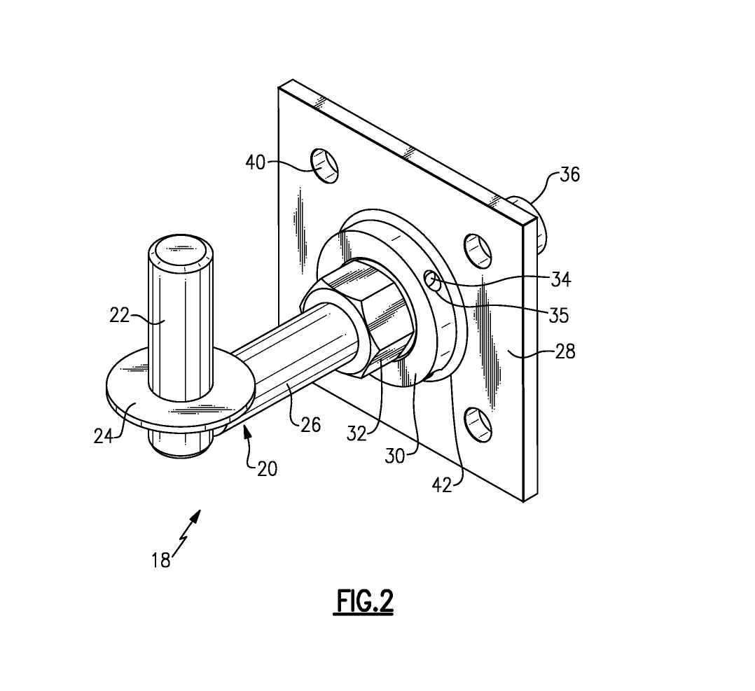

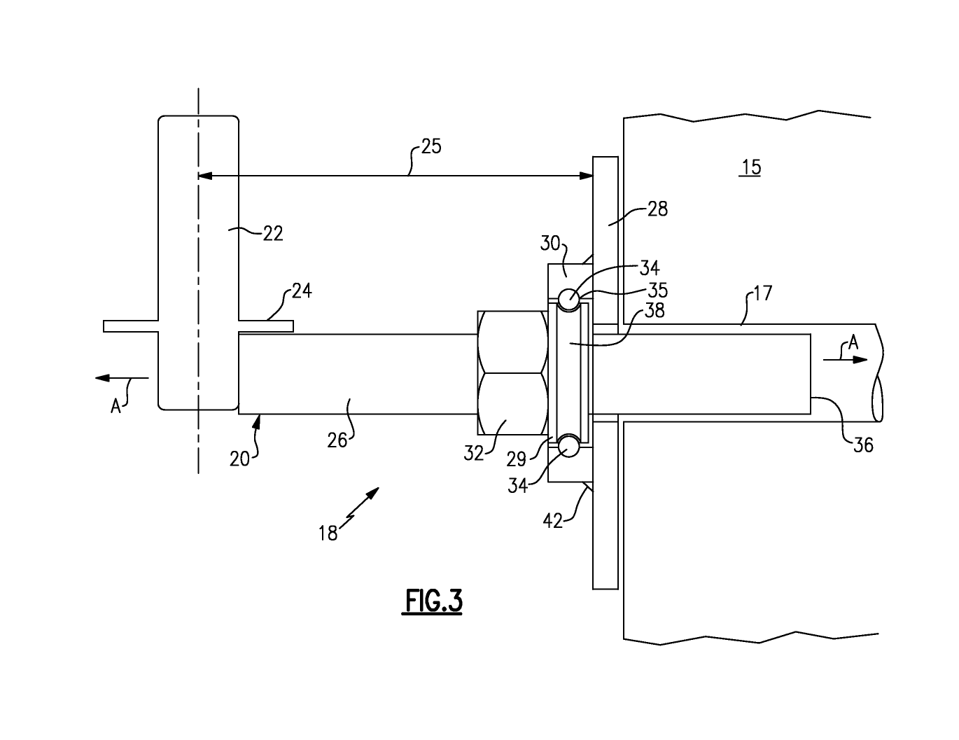

Referring to FIGS. 2 and 3, the example mounting hinge 18 includes a “J” member 20 that includes a horizontal threaded portion 26 and a vertical portion 22. In this example, the vertical portion 22 includes a support flange 24 for supporting a corresponding gate 12. The vertical portion 22 extends upward and is received within an opening (not shown) defined by a post 11 of the gate 12. As appreciated, the mounting hinge 18 shown in FIGS. 2 and 3 includes an upward extending vertical portion 22 and is therefore utilized at a bottom part of the gate 12. The upper mounting hinge 18 would be substantially identical with the vertical portion 22 extending downwardly into a corresponding opening (not shown) of the gate 12. Moreover, in some installations, both the upper and lower mounting hinges 18 would extend upward to facilitate removal of the one of the gates 12 by lifting upward. Accordingly, the mounting hinges 18 could be orientated in different ways as required for a specific application and mounting requirement and remain within the contemplation of this disclosure.

A mounting plate 28 includes openings 40 through which fasteners (not shown) extend for mounting the mounting hinge 18 to one of the fixed posts 15. The mounting plate 28 can be stamped or machined. A fixed housing 30 is attached to the mounting plate 28. The example fixed housing 30 is attached to the mounting plate 28 by a continuous weld 42. It should be understood that it is within the contemplation of this disclosure to attach the housing 30 to the mounting plate 28 by any form of weld or other attachment process. A rear end 36 of the threaded portion 26 extends rearwardly from the mounting plate 28 into an opening 17 defined within the corresponding post 15. As appreciated, the opening 17 is provided to receive the rear end 36 and allow for sufficient horizontal travel to adjust the gaps 14 and 16.

The housing 30 receives pins 34 through corresponding apertures 35 in the housing 30 to retain a horizontal position of an adjustment nut 32. In one example, the adjustment nut 32 is hexagonal in shape. The example adjustment nut 32 includes a larger diameter portion 29 including a groove 38 that is aligned within the housing 30 and the pins 34. The pins 34 are received within the groove 38 to prevent horizontal movement of the adjustment nut 32 relative to the mounting plate 28. However, the pins 34 allow rotation of the adjustment nut 32 to facilitate horizontal movement indicated by arrows “A” responsive to rotation of the adjustment nut 32.

The threaded portion 26 of the J-member 20 can therefore be moved in the direction of the arrows A by rotation of the adjustment nut 32 without changing the orientation of the vertical portion 22. Therefore, the gate 12 can remain in place as the adjustment nut 32 is rotated to adjust a distance 25 between the vertical portion 22 and the mounting plate 28. Adjustment of the distance 25 provides for the adjustment and alignment of the gaps 14 and 16 between the gates 12. The distance 25 is indicated between the mounting plate 28 and a center line of the vertical portion 22. However, the distance 25 is representative of the gap between the inner part of the gate 12 and the corresponding fixed post 15 that correspond to the gaps 14 and 16 between gates 12. Accordingly, the distance 25 could be measured from different parts as an indication of an adjusted distance utilized to provide the desired gaps 14 and 16 at an opposite end of the gate 12.

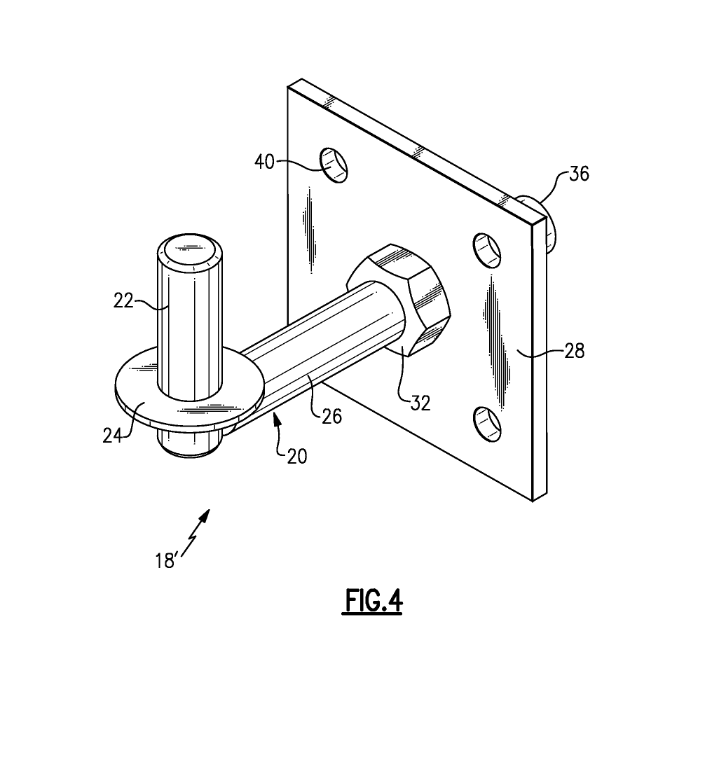

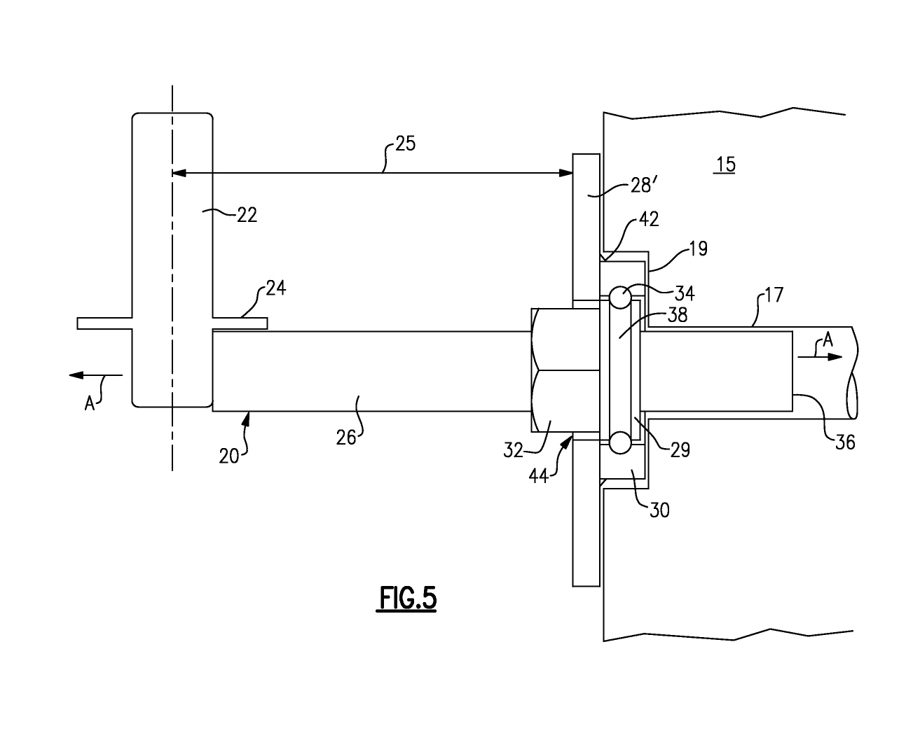

Referring to FIGS. 4 and 5, another mounting hinge 18′ includes features common with those disclosed and described with regard to FIGS. 2 and 3, but for the position of the housing 30. In this example, the housing 30 is mounted to a back side of mounting plate 28′ such that the housing 30 would be at least partially received in a recess 19 in the corresponding fixed post 15. This configuration would present a less cluttered appearance, but would require the addition of the recess 19 in the fixed post 15 or structure to accommodate the housing 30 along with the opening 17 that receives the extended rear end 36 of the threaded portion 26. Further, the mounting plate 28′ includes an opening 44 into which a portion of the adjustment nut 32 is received. The opening 44 provides a clearance fit with the adjustment nut 32 such that the adjustment nut 32 can rotate freely to move the J-member 20.

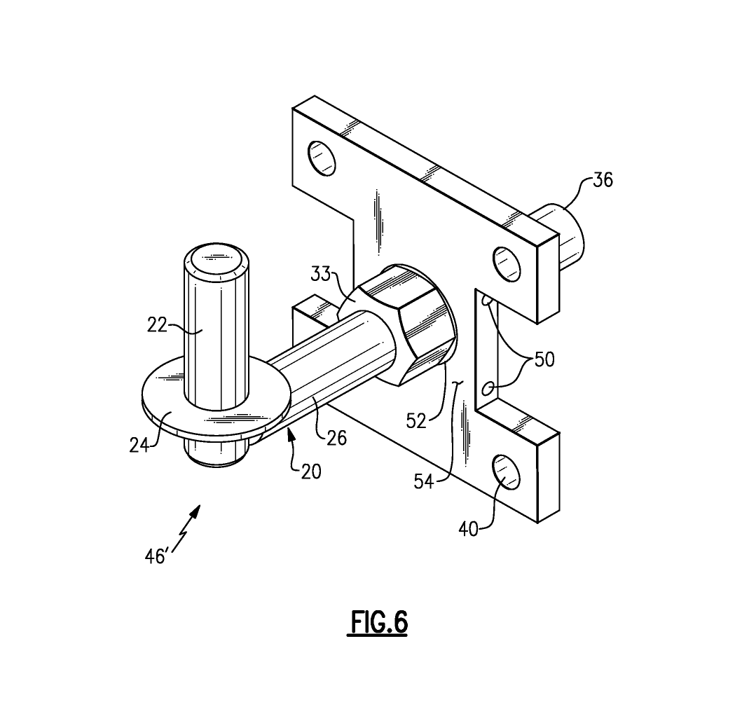

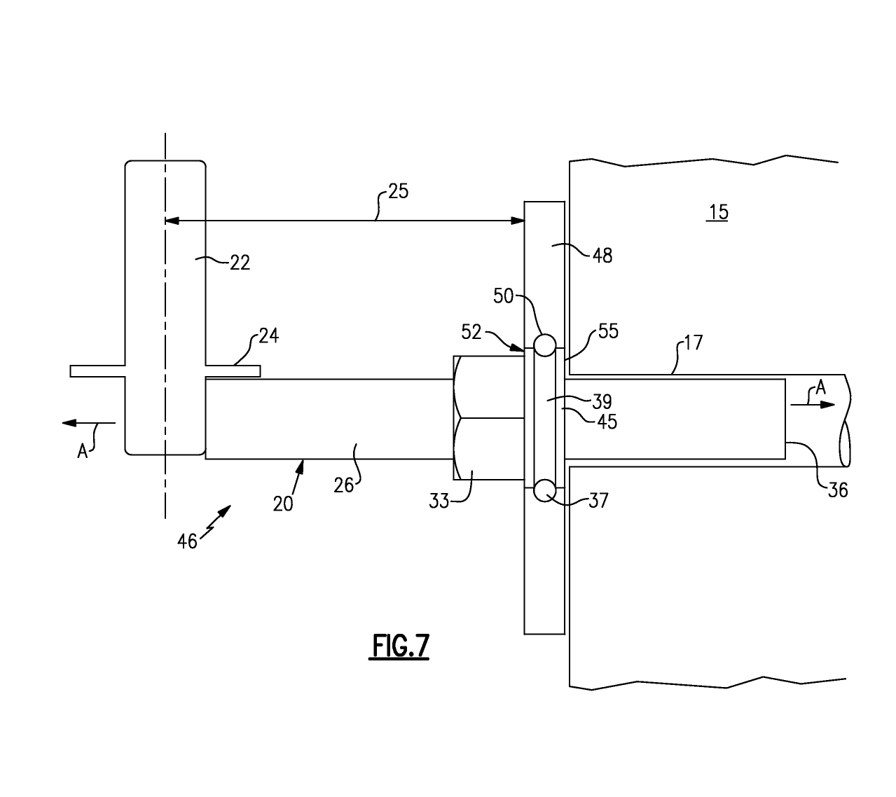

Referring to FIGS. 6 and 7, another example mounting hinge 46 includes a mounting plate 48 including openings 40 through which fasteners (not shown) extend for mounting the mounting hinge 46 to one of the fixed posts 15. The mounting plate 48 can be stamped or machined. The mounting plate 48 includes apertures 50 that receive pins 37 that engage a groove 39 in a larger diameter portion 45 of an adjustment nut 33. The mounting plate 48 includes a necked down portion 54 that defines an opening 52 for larger diameter portion 45 of the adjustment nut 33. The pins 37 extend through the apertures 50 within the thickness of the mounting plate 48 in close proximity to the opening 52 such that a portion of each of the pins 37 is received within the groove 39 of the adjustment nut 33. The adjustment nut 33 is thereby constrained from horizontal movement responsive to rotation such that the J-member 20 moves horizontally to adjust the distance 25 as required to set the gaps 14 and 16. The placement of the groove 39 and the pins 37 are such that a back surface 55 of the adjustment nut 33 is disposed flush with a back side of the mounting plate 48. Accordingly, no accommodation is required in the fixed post 15 for anything other than the rear end 36 of the threaded portion 26. In other words, the mounting plate 48 can be attached directly to the surface of the fixed post 15 with only the opening 17 for receiving the rear end 36 of the threaded portion 26. This example mounting hinge 46 provides a reduced cross-sectional profile that maintains the desired uncluttered appearance. Moreover, this example mounting hinge 46 reduces the number of parts and required secondary assembly.

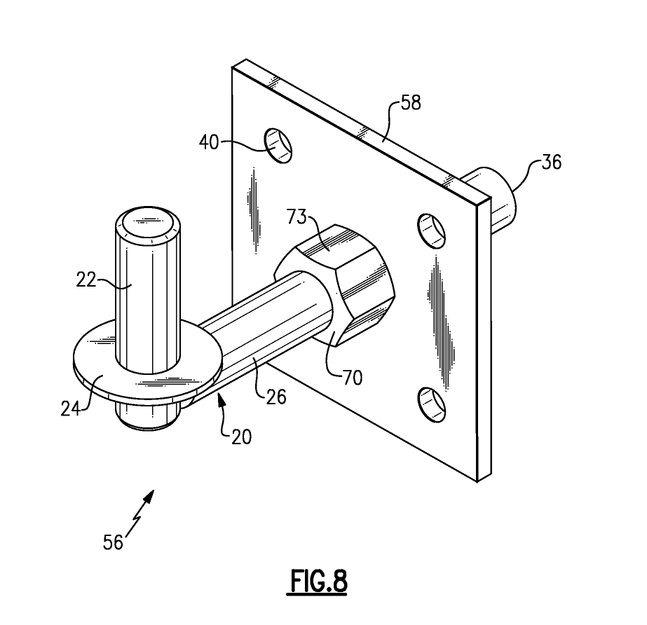

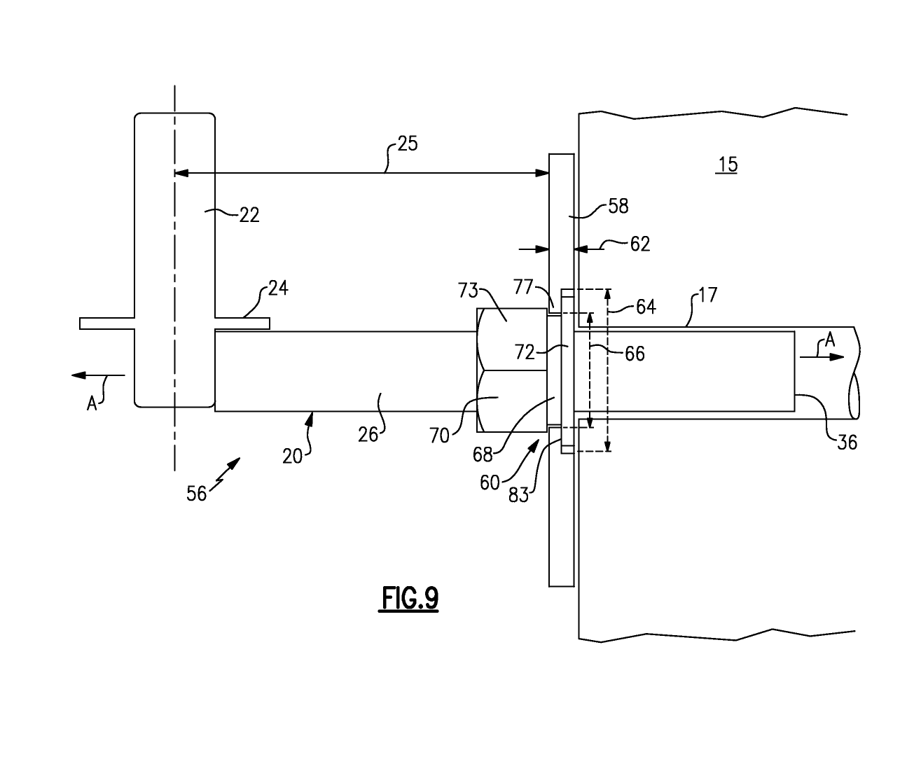

Referring to FIGS. 8 and 9, another example mounting hinge 56 includes a mounting plate 58 including openings 40 through which fasteners (not shown) extend for mounting the mounting hinge 56 to one of the fixed posts 15. The mounting plate 58 can be stamped or machined. The mounting plate 58 defines a stepped opening 60 that receives an adjustment nut 70. The mounting plate 58 includes a thickness 62 within which is disposed the stepped opening 60 having a portion with a large diameter 64 proximate to the fixed post 15 and a portion with a constraining small diameter 66 distal to the fixed post 15 that receives a portion of the adjustment nut 70. As the constraining small diameter 66 is smaller than the large diameter 64, the stepped opening 60 defines a flange 77 that defines the constraining small diameter 66. The adjustment nut 70 includes a large flange 72 that is received within the large diameter 64 and a small flange 68 that is received in the constraining small diameter 66 and disposed between the large flange 72 and a body 73 of the adjustment nut 70 (the body 73 including the hexagonal sides, in one example). A front side 83 of the large flange 72 abuts the flange 77 of the mounting plate 58 within the stepped opening 60.

The combined thicknesses of the flanges 68 and 72 are equal to the thickness 62 of the mounting plate 58. The small flange 68 is located within the portion of the stepped opening 60 including the constraining small diameter 66, and the large flange 72 is located in the portion of the stepped opening 60 including the large diameter 64. The large flange 72 is larger than the constraining small diameter 66, which retains the adjustment nut 70 within the mounting plate 58. The large flange 72 is received within the thickness 62 of the mounting plate 58 such that the mounting plate 58 can be mounted flat against the fixed post 15. The flange 77 further prevents horizontal movement of the adjustment nut 70 relative to the mounting plate 58 due to the fact that the flange 77 has a smaller diameter than the diameter of the larger flange 72. The body 73 of the adjustment nut 70 extends out from the front of the mounting plate 58.

Once the mounting plate 58 is attached to a fixed post 15, a back side of the larger flange 72 abuts the fixed post 15 and along with the constraining small diameter 66, constrains horizontal movement of the adjustment nut 70. Therefore, rotation of the adjustment nut 70 will move the J-member 20, while maintaining the adjustment nut 70 in a fixed horizontal position. When the mounting hinge 56 is not mounted to the fixed post 15, the adjustment nut 70 can move freely through the back side of the mounting plate 58. However, once installed, the adjustment nut 70 is retained by the mounting plate 58 against the fixed post 15.

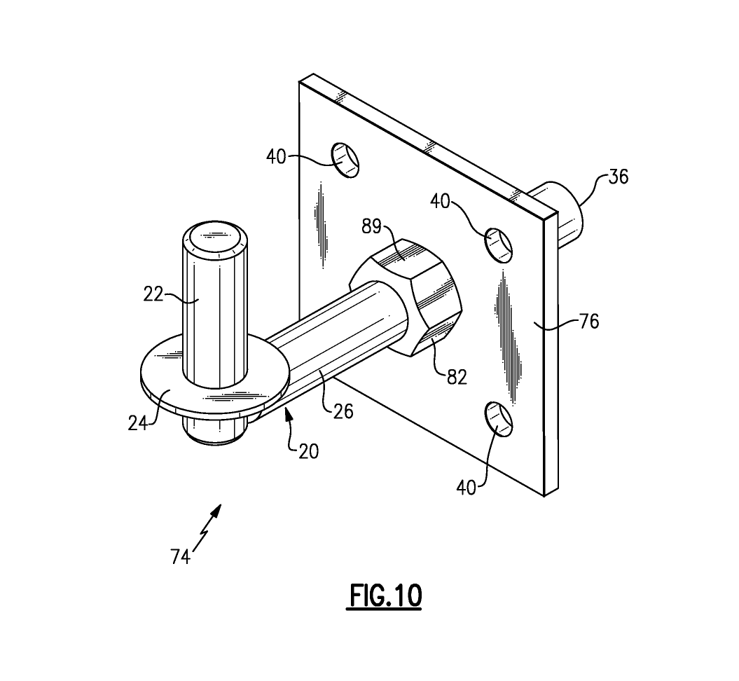

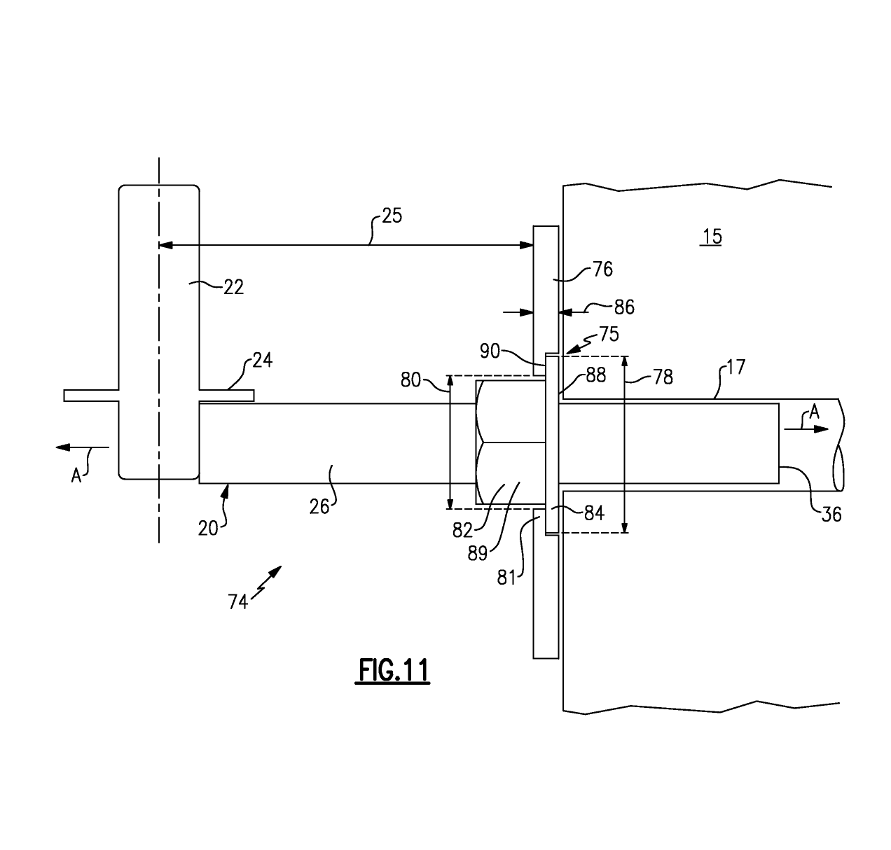

Referring to FIGS. 10 and 11, another example mounting hinge 74 includes a mounting plate 76 including openings 40 through which fasteners (not shown) extend for mounting the mounting hinge 74 to one of the fixed posts 15. The mounting plate 76 can be stamped or machined. The mounting plate 76 includes a thickness 86 within which is disposed a stepped opening 75 having a portion with a large diameter 78 proximate to the fixed post 15 and a portion with a small diameter 80 distal to the fixed post 15 and defined by a flange 81 that receives a portion of the adjustment nut 82.

The adjustment nut 82 includes a flange 84 with a front side 90 that abuts the flange 81 of the mounting plate 76 within the stepped opening 75. The small diameter 80 defined by the flange 81 is large enough to receive a body 89 of the adjustment nut 82, but too small to allow for passage of the flange 84. Therefore, the body 89 of the adjustment nut 82 extends out from the front of the mounting plate 76.

Once the mounting plate 76 is attached to a fixed post 15, a back side of the flange 88 abuts the fixed post 15 and along with flange 81 having the smaller diameter 80, constrains horizontal movement of the adjustment nut 82. Therefore, rotation of the adjustment nut 82 will move the J-member 20, while maintaining the adjustment nut 82 in a fixed horizontal position. When the mounting hinge 74 is not mounted to the fixed post 15, the adjustment nut 82 can be moved freely through the back side of the mounting plate 76. However, once installed, the adjustment nut 82 is retained by the mounting plate 76 against the fixed post 15.

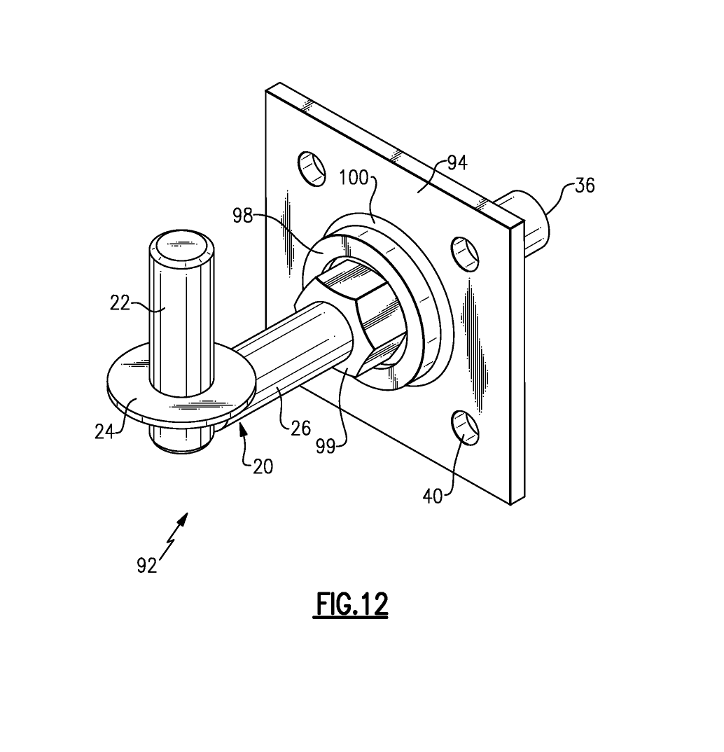

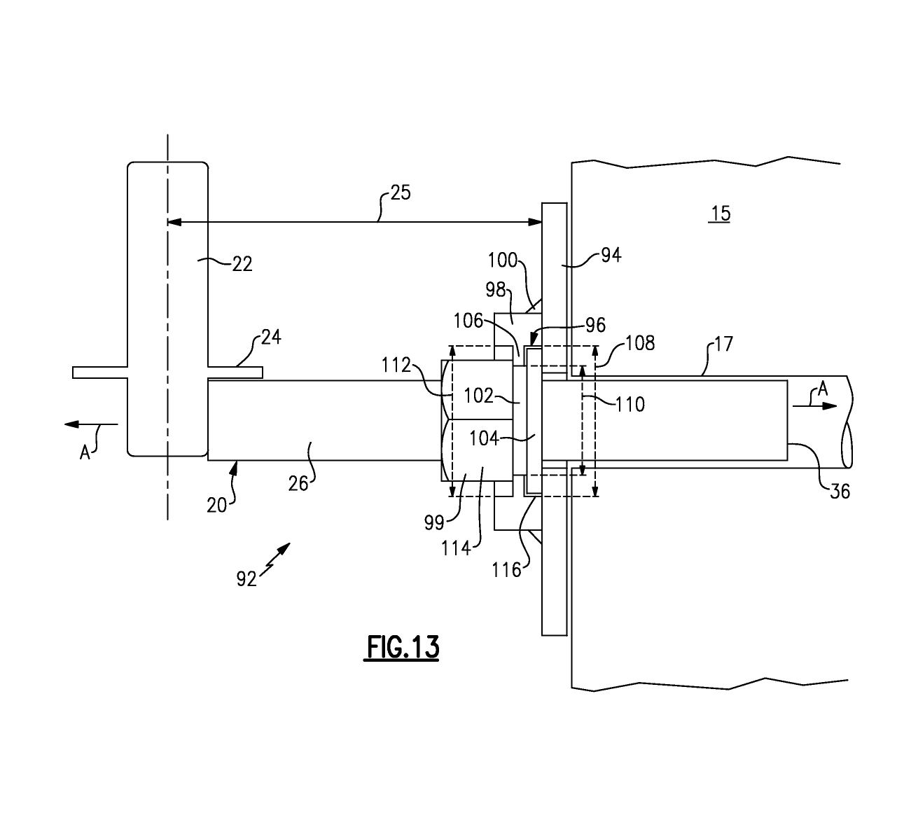

Referring to FIGS. 12 and 13, another example mounting hinge 92 includes a mounting plate 94 including openings 40 through which fasteners (not shown) extend for mounting the mounting hinge 92 to one of the fixed posts 15. The mounting plate 94 can be stamped or machined. Attached to the mounting plate 94 is a fixed housing 98. The example fixed housing 98 is attached to the mounting plate 94 by a continuous weld 100. It should be understood that it is within the contemplation of this disclosure to attach the housing 98 to the mounting plate 94 by any form of weld or other attachment process.

The housing 98 defines a stepped opening 96 that receives an adjustment nut 99. The stepped opening 96 includes three portions of different diameters. The stepped opening 96 includes a portion having a diameter 108, a portion having a diameter 112, and portion a having diameter 110 therebetween that is smaller than the diameters 108 and 112 and defined by a flange 106 formed by the housing 98. The adjustment nut 99 includes a body 114, a large flange 104 having a diameter, and a small flange 102 including a diameter smaller than the diameter of the large flange 104, and the small flange 102 is located between the body 114 and the large flange 104 (which both have larger diameters) to define a groove 116 therebetween. The large flange 104 is received within the portion of the stepped opening 96 having the diameter 108, the small flange 102 is received within the portion of the stepped opening 96 having the smaller diameter 110, and the body 114 is received in the portion of the stepped opening 96 having the diameter 112.

The large flange 104 of the adjustment nut 99 is retained between the flange 106 of the housing 98 and the mounting plate 94, retaining the adjustment nut 99 to the mounting plate 94. Accordingly, rotation of the adjustment nut 99 moves the J-member 20 horizontally to adjust the distance 25 without moving the adjustment nut 99 horizontally. Moreover, the flange 106 is received within the groove 116 such that the mounting plate 94 can be mounted flat against the fixed post 15 and to prevent further horizontal movement of the adjustment nut 99 relative to the mounting plate 94.

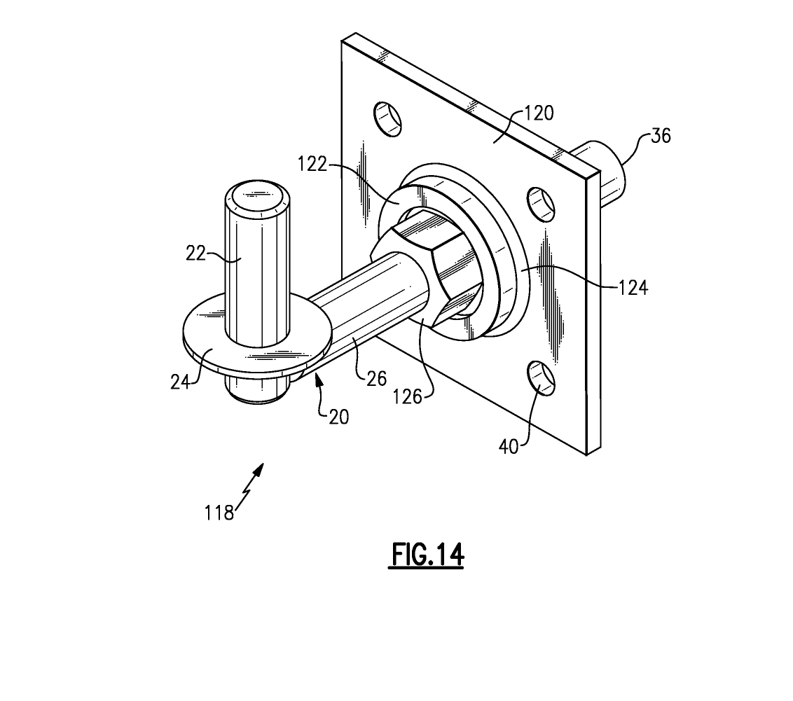

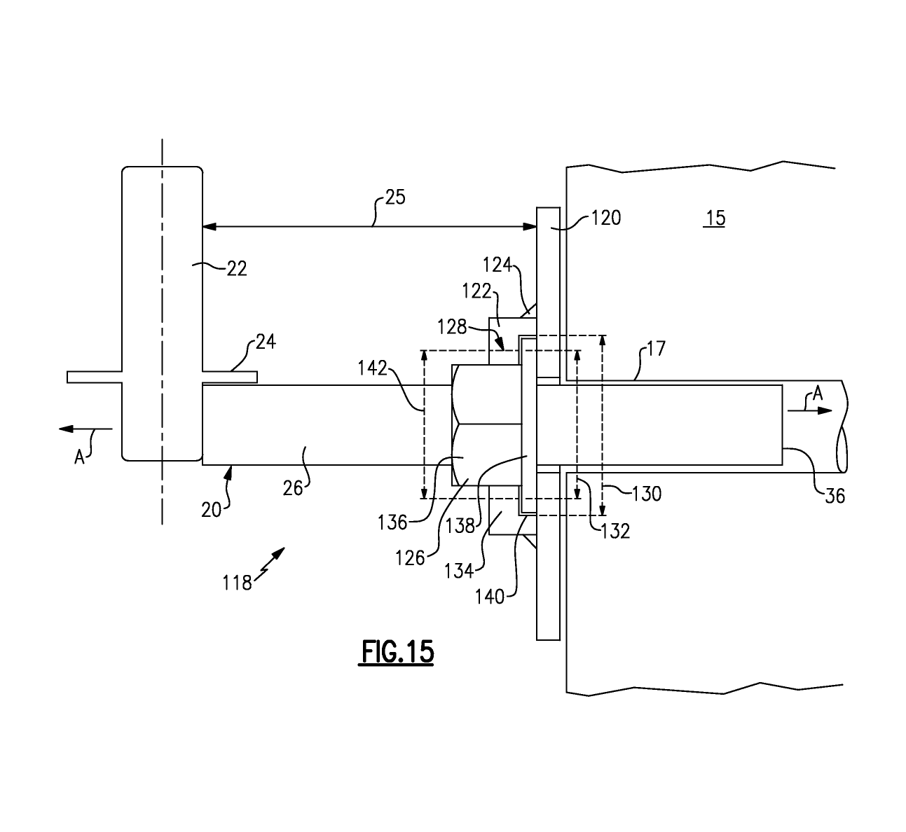

Referring to FIGS. 14 and 15, another example mounting hinge 118 includes a mounting plate 120 including openings 122 through which fasteners (not shown) extend for mounting the mounting hinge 118 to one of the fixed posts 15. The mounting plate 120 can be stamped or machined. A fixed housing 122 is attached to the mounting plate 120. The example fixed housing 122 is attached to the mounting plate 120 by a continuous weld 124. It should be understood that it is within the contemplation of this disclosure to attach the housing 122 to the mounting plate 120 by any form of weld or other attachment process.

The housing 98 defines a stepped opening 128 that receives an adjustment nut 126. The stepped opening 128 has a portion with a large diameter 130 proximate to the fixed post 15 and a portion with a small diameter 132 distal to the fixed post 15 and defined by a flange 134 of the housing 122. The adjustment nut 126 includes a body 136 and a flange 138 that has a larger diameter than the body 136. The flange 138 is received within the portion of the opening 128 having the large diameter 130 that defines a groove 140, and the body 136 is received in portion of the stepped opening 128 having a diameter 142. The flange 138 of the adjustment nut 126 is retained between the flange 134 of the housing 122 and the mounting plate 120, retaining the adjustment nut 126 to the mounting plate 120.

Accordingly, rotation of the adjustment nut 126 moves the J-member 20 horizontally to adjust the distance 25 without moving the adjustment nut 126 horizontally. Moreover, the flange 138 is received within the groove 140 such that the mounting plate 120 can be mounted flat against the fixed post 15 and to prevent further horizontal movement of the adjustment nut 126 relative to the mounting plate 94.

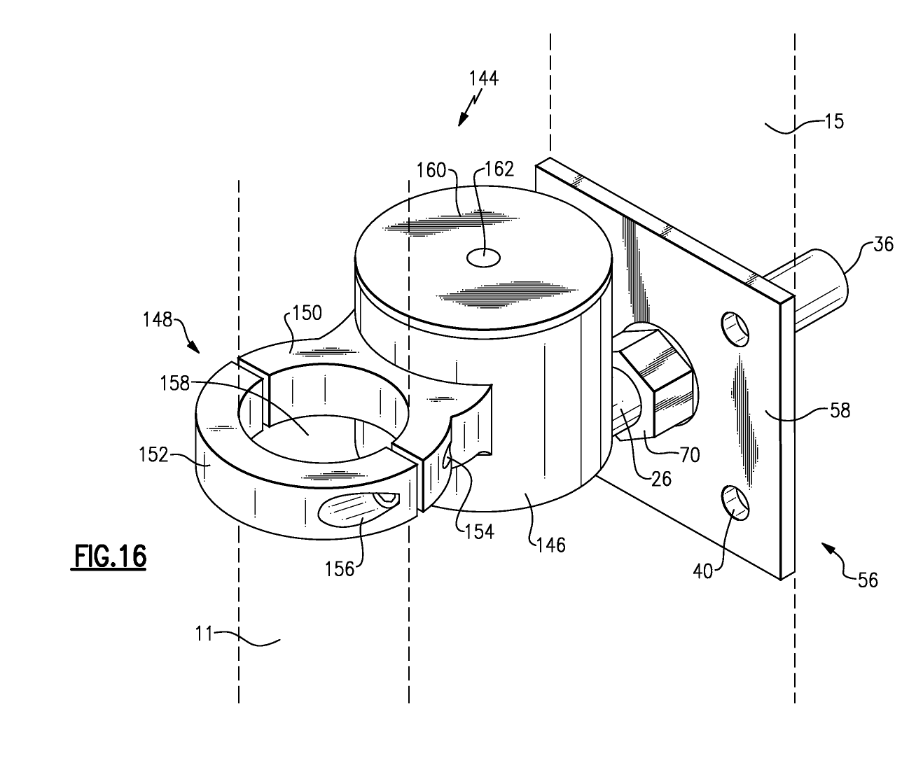

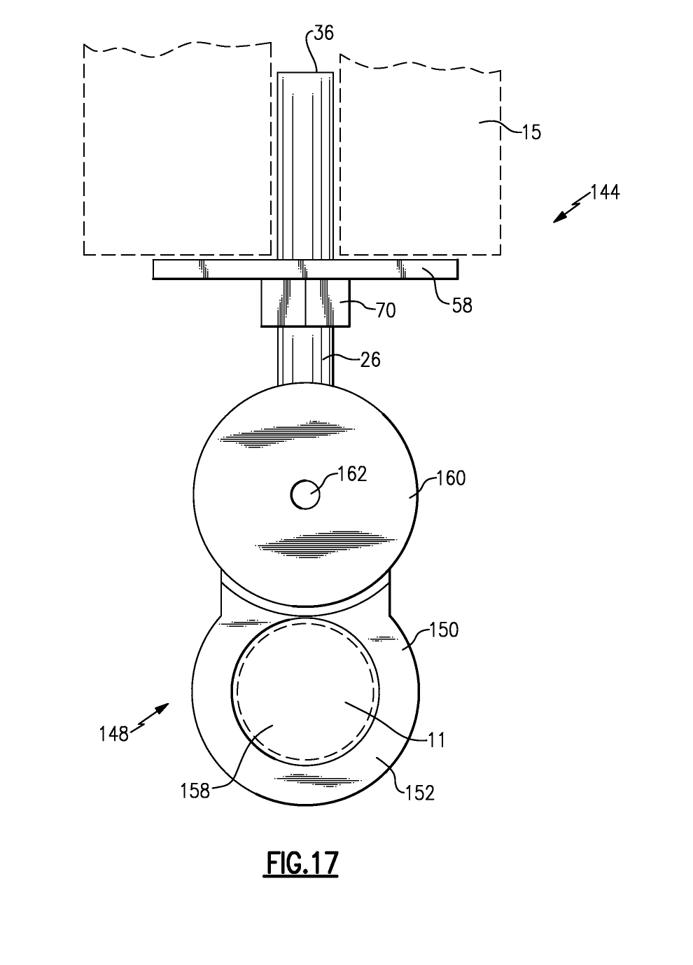

FIGS. 16 to 18 show an example clamp 144 that receives the vertical portion 22 and is attached to the post 11 of the gate 12. In the example shown and described, the clamp 144 is used with the mounting hinge 56. However, the clamp 144 can be employed with any of the above-described and illustrated mounting hinges.

The clamp 144 includes a hollow cylindrical body 146 and a clamp 148 including a first clamp portion 150 attached to the hollow cylindrical body 146 and a detached second clamp portion 152, each including an aperture 154 and 156, respectively, that together define an opening 158. A fastener (not shown) is received in the aperture 154 and 156 to secure the clamp portions 150 and 152 together. The post 11 of the gate 12 is received in the opening 158. A cover 160 is located on an upper portion of the hollow cylindrical body 146 and is secured to the vertical portion 22 by a fastener 162. The hollow cylindrical body 146 is rotatable relative to the cover 160. The cover 160 includes a circumferential bushing 164 that receives an upper portion of the vertical portion 22 to provide alignment.

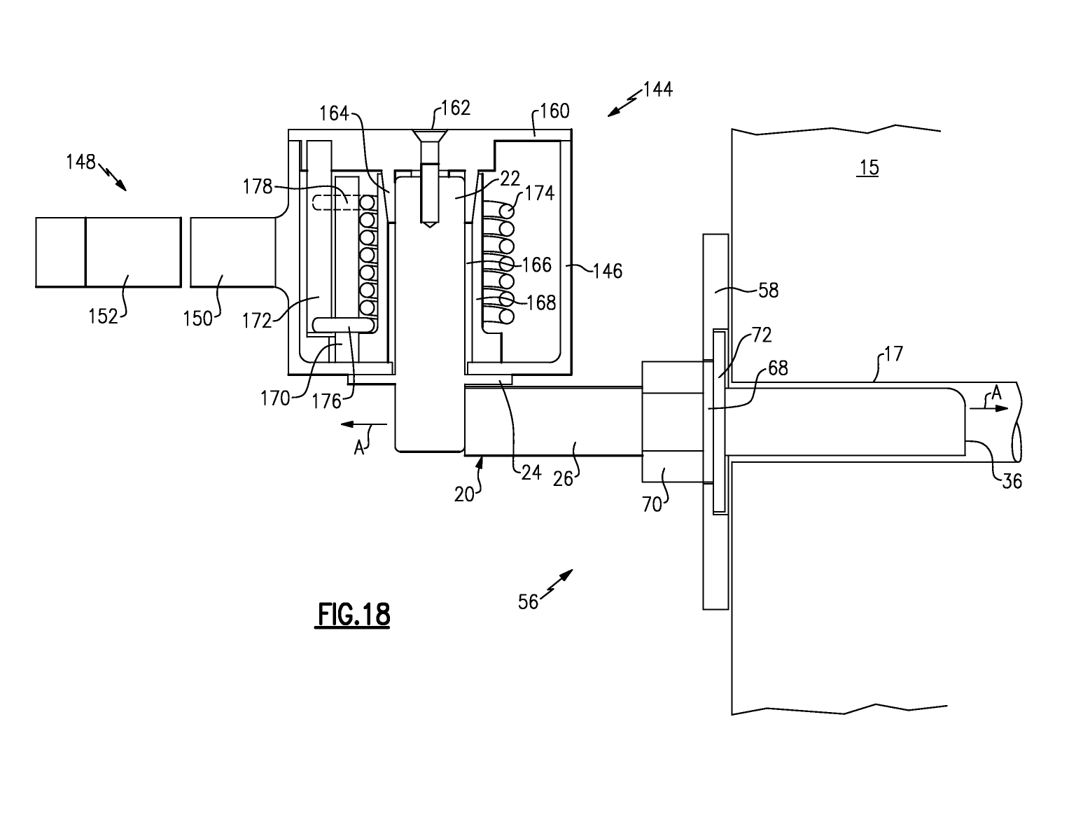

The clamp 144 includes a bushing 166 located between the vertical portion 22 and a rotatable mandrel 168 attached to the hollow cylindrical body 146. A vertical member 170 is attached to the rotatable mandrel 168, and an adjacent vertical member 172 is attached to the cover 160. In one example, the vertical members 170 and 172 are pins. A resilient member 174, such as a spring, is located between the vertical member 170 and the rotatable mandrel 168. The resilient member 174 is pre-loaded and includes a first arm 176 and a second arm 178. As shown in FIG. 18, the first arm 176 is located on a first side of the vertical members 170 and 172, and the second arm 178 (shown in dashed lines) is located on an opposing second side of the vertical members 170 and 172. That is, the first arm 176 and the second arm 178 are separated by the vertical members 170 and 172.

In reference to FIG. 18, the gate 12 can rotate 90° into the page and 90° out of the page. When the hollow cylindrical body 146 rotates in either direction upon movement of the gate 12, the vertical member 170 rotates therewith and away from the vertical member 172, moving the arms 176 and 178 apart. As the resilient member 174 is pre-loaded, the resilient member 174 returns the gate 12 to the position shown in FIG. 18 upon release of the gate 12.

Accordingly, the disclosed example mounting hinges facilitate gate adjustment with the gate in an assembled condition. Moreover, the example mounting hinges provide a continuous infinite amount of adjusting positions as the J-member itself need not be rotated to perform any adjustment.

Although an example of the mounting hinge has been disclosed, a worker of ordinary skill in this art would recognize that certain modifications would come within the scope of this disclosure. For that reason, the following claims should be studied to determine the true scope and content of this invention.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1. A mounting hinge for supporting a movable gate comprising:
a mounting plate attachable to a fixed structure;
an adjustment member constrained from horizontal movement by the mounting plate; and
a gate supporting member engaged with the adjustment member and movable responsive to a rotation of the adjustment member relative to the mounting plate.

2. The mounting hinge as recited in claim 1 wherein the adjustment member is a nut.

3. The mounting hinge as recited in claim 1 wherein the gate supporting member includes a horizontal threaded portion received in a hole in the adjustment member and a vertical portion received with an opening of a post of the moveable gate.

4. The mounting hinge as recited in claim 3 wherein the horizontal threaded portion moves in response to the rotation of the adjustment member.

5. The mounting hinge as recited in claim 1
wherein the mounting hinge includes a housing fixed to the mounting plate, the housing including an internal opening and an external aperture in communication with the internal opening,
wherein the adjustment member includes a body having a diameter and a flange having a larger diameter than the diameter of the body, wherein the flange includes a groove that is received in the internal opening of the housing, and
wherein a pin is received in the external aperture of the housing and in a portion of the groove in the flange of the adjustment member to prevent horizontal movement of the adjustment member relative to the mounting plate and allow rotation of the adjustment member to horizontally move the gate supporting member.

6. The mounting hinge as recited in claim 1
wherein the mounting plate includes an internal opening and an external aperture in communication with the internal opening,
wherein the adjustment member includes a body having a diameter and a flange having a larger diameter than the diameter of the body, and the flange of the adjustment member includes a groove and is received in the internal opening of the mounting plate, and
wherein a pin is received in the external aperture of the mounting plate and in a portion of the groove in the flange of the adjustment member to prevent horizontal movement of the adjustment member relative to the mounting plate and allow rotation of the adjustment member to horizontally move the gate supporting member.

7. The mounting hinge as recited in claim 1
wherein the mounting plate includes an internal opening having a first portion with a small diameter and a second portion with a large diameter, and the small diameter of the first portion of the internal opening is defined by a flange of the mounting plate, and
wherein the adjustment member includes a body, a first flange sized to be received in the first portion of the internal opening and a second flange sized to be received in the second portion of the internal opening, and the second flange of the adjustment member is constrained by the flange of the mounting plate and the fixed structure to prevent horizontal movement of the adjustment member relative to the mounting plate and allow rotation of the adjustment member to horizontally move the gate supporting member.

8. The mounting hinge as recited in claim 1
wherein the mounting plate includes an internal opening having a first portion with a small diameter and a second portion with a large diameter, and the small diameter of the first portion of the internal opening is defined by a mounting plate flange, and
wherein the adjustment member includes a body and an adjustment member flange sized to be received in the second portion of the internal opening, and the adjustment member flange of the adjustment member is constrained by the mounting plate flange and the fixed structure to prevent horizontal movement of the adjustment member relative to the mounting plate and allow rotation of the adjustment member to horizontally move the gate supporting member.

9. The mounting hinge as recited in claim 1
wherein the mounting hinge includes a housing fixed to the mounting plate, the housing including an internal opening having a first portion, a second portion, and a third portion defined between the first portion and the second portion, and a housing flange defines the third portion having a diameter that is smaller than a diameter of the first portion and a diameter of the second portion, and
wherein the adjustment member includes a body, a first flange sized to be received in the third portion of the internal opening and a second flange sized to be received in the second portion of the internal opening, and the second flange of the adjustment member has a diameter larger than the diameter of the third portion of the internal opening, and the adjustment member is constrained by the housing flange of the housing and the mounting plate to prevent horizontal movement of the adjustment member relative to the mounting plate and allow rotation of the adjustment member to horizontally move the gate supporting member.

10. The mounting hinge as recited in claim 1
wherein the mounting hinge includes a housing fixed to the mounting plate, the housing including an internal opening having a first portion with a small diameter and a second portion with a larger diameter, and a housing flange defines the small diameter, and
wherein the adjustment member includes a body and an adjustment member flange, and the adjustment member flange is sized to be received in the second portion of the internal opening and has a diameter larger than the small diameter of the first portion of the internal opening, and the adjustment member is constrained by the housing flange of the housing and the mounting plate to prevent horizontal movement of the adjustment member relative to the mounting plate and allow rotation of the adjustment member to horizontally move the gate supporting member.

11. The mounting hinge as recited in claim 1 further including a resilient member loaded clamp that returns the moveable gate to an original position once the moveable gate is moved from the original position.

12. The mounting hinge as recited in claim 11 wherein the gate support member is received in an opening in the resilient member loaded clamp, and the resilient member loaded clamp includes a clamp portion that receives a post of the moveable gate.

13. A movable gate comprising:
a mounting plate attachable to a fixed post;
an adjustment member constrained from horizontal movement by the mounting plate;
a gate supporting member engaged with the adjustment member and movable responsive to a rotation of the adjustment member relative to the mounting plate, wherein the gate supporting member includes a horizontal threaded portion received in a hole in the adjustment member and a vertical portion; and
a rotatable gate including a post, wherein the vertical portion of the gate supporting member is received within an opening of the post of the rotatable gate.

14. The moveable gate as recited in claim 13 wherein the adjustment member is a nut.

15. The moveable gate as recited in claim 13 wherein the adjustment gate supporting member has a substantial J shape.

16. The moveable gate as recited in claim 13 wherein there are two gate supporting members and two mounting plates attached to the fixed post.

17. A method of adjusting a position of a movable gate, the method comprising the steps of:
attaching a mounting plate to a fixed support;
constraining horizontal movement of an adjustment member supported by the mounting plate;
supporting a movable gate support member with the adjustment member; and
rotating the adjustment member to move the gate support member relative to the fixed support to a desired position indicative of a desired gate alignment.
